(19) United States
(12) Patent Application Publication
(10) Pub. No.: US 2009/0172279 A1
(43) Pub. Date: Jul. 2, 2009

(54) System For Accessing A Removable Non-Volatile Memory Card

(76) Inventors: Po Yuan, Milpitas, CA (US); Robert Chin-Tse Chang, Danville, CA (US); Mei Yan, Cupertino, CA (US); Bahman Qawami, San Jose, CA (US); Farshid Sabet-Sharghi, Los Altos Hills, CA (US); Matthijs C. Hutten, Redwood City, CA (US); Gusti Averbuch, Modiin (IL)

Correspondence Address: BRINKS HOFER GILSON & LIONE/SanDisk, P.O. BOX 10395, CHICAGO, IL, 60610, US

(21) Appl. No.: 11/966,650

(22) Filed: Dec. 28, 2007

(51) Int. Cl. G06F 12/00

(52) U.S. Cl. 711/115; 711/E12.001

(57) ABSTRACT

A non-volatile memory interface device contains first, second, and third communication interfaces configured for first, second, and third protocols, respectively. The device also contains a memory controller that selectively communicates between the first and second communication interfaces, and between the first and third communication interfaces. The device also contains a receptacle that can receive a removable non-volatile memory card and electrically connect the card to the second and third communication interfaces. The first communication interface may be a Universal Serial Bus Interface and may be in communicatively coupled to a USB connector. The second communication interface may be an ISO 7816 interface. A communications adapter is an enclosure containing a receptacle that can receive a non-volatile memory card and a USB connector. The USB connector is communicatively coupled with the non-volatile memory card in the receptacle. The receptacle's second communication interface with the non-volatile memory card is disabled.

### TECHNICAL FIELD

This application relates generally to the operation of non-volatile flash memory systems, and, more specifically, to a system for accessing a removable non-volatile memory card.

### BACKGROUND

There are many commercially successful non-volatile memory products being used today, particularly in the form of small form factor cards, which employ flash EEPROM (Electrically Erasable and Programmable Read Only Memory) cells formed on one or more integrated circuit devices. Some of the commercially available card formats include Smart Cards, Subscriber Identity Module (SIM), and Removable User Identity Module (R-UIM) cards. These cards typically contain memory and a microcontroller (with associated logic memory and software). The data stored within a card is accessed via an interface that is controlled by a program and, in some cases, security hardware or software.

Typically, SIM cards and R-UIM cards are utilized in cellular phones operating on Global System for Mobile communication (GSM) and Code Division Multiple Access (CDMA) networks, respectively. In these applications, SIM and R-UIM cards store limited amounts of information, such as encryption keys, subscriber identification values, and telephone contact lists. However, as the storage density of non-volatile memory has increased, more non-volatile memory may be contained within a storage card such as a SIM card. The additional storage may be utilized for a variety of advanced cellular telephone services, such as storing Multimedia Messaging Service (MMS) object attachments, MP3 audio files, high-resolution images files, and video files, as well as providing full personal information management (PIM) functionality, such as e-mail contact lists and calendars. An example of a high-capacity SIM card is the SIM 5000™, a memory device from SanDisk Corporation of Milpitas, Calif.

The greater storage capacity of a high-capacity SIM card necessitates a faster interface to access the storage contents. The ISO 7816 interface utilized on a typical Smart Card, SIM card, or R-UIM card may be supplemented with an additional high speed interface, such as a Multimedia Card (MMC) interface, a Secure Digital (SD) interface, a Universal Serial Bus (USB) interface, or a serial ATA (SATA) interface, in order to access the storage space of high-capacity cards. The relatively slower ISO 7816 interface may still be utilized for backwards-compatibility purposes, or to limit access to the storage accessible over the high-speed interface.

### SUMMARY

In order to address these issues, there is a need for a way to update, erase, or read the contents of a high-capacity SIM card, R-UIM card, or Smart Card using a variety of hosts. There is also a need for a way to write new contents to a high-capacity SIM card, R-UIM card, or Smart Card using a variety of hosts.

Thus, according to one embodiment, there is a system for accessing a removable non-volatile memory card. Such a system may include a non-volatile memory interface device that contains a first communication interface which uses a first protocol, a second communication interface which uses a second protocol, and a third communication interface which uses a third protocol. In this embodiment the non-volatile memory interface device also contains a memory controller that selectively communicates between the first communication interface and the second communication interface, and between the first communication interface and the third communication interface. The non-volatile memory interface device in this embodiment further contains a receptacle that can receive a removable non-volatile memory card, where the receptacle contains electrical contacts that can be in conductive contact with at least one electrical contact of the received removable non-volatile memory card, and where the second communication interface and the third communication interface are communicatively coupled to the electrical contacts of the receptacle.

In another embodiment, a system for accessing a removable non-volatile memory card is provided. In this embodiment, a non-volatile memory interface device can receive a removable non-volatile memory card, where the removable non-volatile memory card is at least partially accessible through two communication interfaces. The non-volatile memory interface device in this embodiment further contains a Universal Serial Bus interface, and a receptacle that can receive the removable non-volatile memory card, where the receptacle contains electrical contacts that can be in conductive contact with at least one electrical contact of the received removable non-volatile memory card. The non-volatile memory interface device in this embodiment also contains a memory controller communicatively coupled to the Universal Serial Bus interface and the receptacle, and can communicate with the removable non-volatile memory card received in the receptacle utilizing at least one of the two communication interfaces, where each communication interface has a different protocol, and can also communicate with the Universal Serial Bus interface using a Universal Serial Bus protocol.

According to another embodiment, there is a system for accessing a removable non-volatile memory card. Such may include a non-volatile memory interface device with a receptacle that can receive a removable non-volatile memory card, where the receptacle contains electrical contacts that can be in conductive contact with at least one electrical contact of the received removable non-volatile memory card, where the removable non-volatile memory card is at least partially accessible in an ISO 7816 protocol and a second protocol. The non-volatile memory interface device in this embodiment also contains a Universal Serial Bus connector, and a memory controller communicatively coupled to the Universal Serial Bus connector and the receptacle. The memory controller in this embodiment can store data to and read data from the removable non-volatile memory card received in the receptacle according to the ISO 7816 protocol and a second protocol, and the memory controller also can transmit data to and receive data from the Universal Serial Bus connector according to a Universal Serial Bus protocol. The non-volatile memory interface device in this embodiment has an enclosure that contains the receptacle, the Universal Serial Bus connector, and the memory controller.

In yet another embodiment, a system for accessing a removable non-volatile memory card is provided. A communications adapter in this embodiment can receive a removable non-volatile memory card, where the removable non-volatile memory card is at least partially accessible through a Universal Serial Bus interface and a second interface. The communications adapter also contains a receptacle that can receive the removable non-volatile memory card, where the receptacle contains electrical contacts that can be in conductive contact with at least one electrical contact of the received removable non-volatile memory card. The communications adapter in this embodiment further contains a Universal Serial Bus interface connector, and has an enclosure containing the receptacle and the Universal Serial Bus connector. The Universal Serial Bus interface connector in this embodiment is communicatively coupled with at least two of the electrical contacts of the receptacle that can be in conductive contact with the electrical contacts of the Universal Serial Bus interface of the non-volatile memory card. The electrical contacts of the second interface of the non-volatile memory card in this embodiment are individually configured to receive a constant voltage. The form factor of the removable non-volatile memory card accepted by the communications adapter of this embodiment may be the UICC ID1 form factor, the UICC ID-000 form factor, or the mini-UICC form factor.

Other methods and systems, and features and advantages thereof, will be, or will become, apparent to one with skill in the art upon examination of the following figures and detailed description. It is intended that the scope of the invention will include the foregoing and all such additional methods and systems, and features and advantages thereof.

### BRIEF DESCRIPTION OF THE DRAWINGS

The components in the figures are not necessarily to scale, emphasis instead being placed upon illustrating the principle aspects of various embodiments of the system and method. Moreover, in the figures, like referenced numerals designate corresponding parts throughout the different views.

FIG. 1 is a diagram illustrating a system using a storage adapter device to access a non-volatile memory card, in accordance with an embodiment.

FIG. 2A is a diagram illustrating an additional embodiment of an enclosure for a storage adapter.

FIG. 2B is a diagram illustrating an additional embodiment of an enclosure for a storage adapter.

FIG. 3 is a diagram illustrating some of the non-volatile memory card form factors that may be utilized with a storage adapter, in accordance with an embodiment.

FIG. 4 is a diagram illustrating exemplary electrical contact assignments that may be used by a non-volatile memory card, in accordance with an embodiment.

FIG. 5 is a diagram illustrating an exemplary system for accessing a removable non-volatile memory card, in accordance with an embodiment.

FIG. 6 is a diagram illustrating an exemplary system for accessing a removable non-volatile memory card, in accordance with an embodiment.

### DETAILED DESCRIPTION OF THE PRESENTLY PREFERRED EMBODIMENTS

An R-UIM card or SIM card may typically store limited amounts of information, such as encryption keys, subscriber identification values, and telephone contact lists. Cellular phones that utilize R-UIM cards or SIM cards are increasingly used to capture, store, share, receive, and transmit other data, such as digital pictures, audio files such as MP3 audio format files, Multimedia Message Service (MMS) messages and attachments, calendars, e-mail messages, and other digital files. To accommodate the additional storage requirements, some cellular phones incorporate a receptacle for a non-volatile removable media card, such as a CompactFlash (CF) card, a MultiMedia (MMC) card, or a Secure Digital (SD) card. As the density of non-volatile storage memory has increased, the storage capacities of R-UIM card or SIM cards may also be increased, to the point where, in some instances, the R-UIM or SIM card may replace all of the non-volatile storage previously provided by the additional non-volatile removable media card.

In one example, SIM cards containing additional memory may be referred to as high-capacity SIM cards. An example of a high-capacity SIM card is the SIM 5000™, a memory device from SanDisk Corporation of Milpitas, Calif. In addition to an ISO 7816 interface, a high-capacity SIM card may contain a high speed interface, such as Multimedia Card (MMC), Secure Digital (SD), Universal Serial Bus (USB), or serial ATA (SATA) in order to access the expanded storage space.

Typically, a high-capacity SIM card may be utilized within a cellular phone, where the encryption keys, subscriber identification values, and telephone contact lists may be utilized in the operation of the telephone. While a cellular phone may read, modify, and write the multimedia files on a high-capacity SIM card installed in a cellular phone, it is desirable to access the multimedia files and other stored contents using other devices, such as a personal computer or a media player.

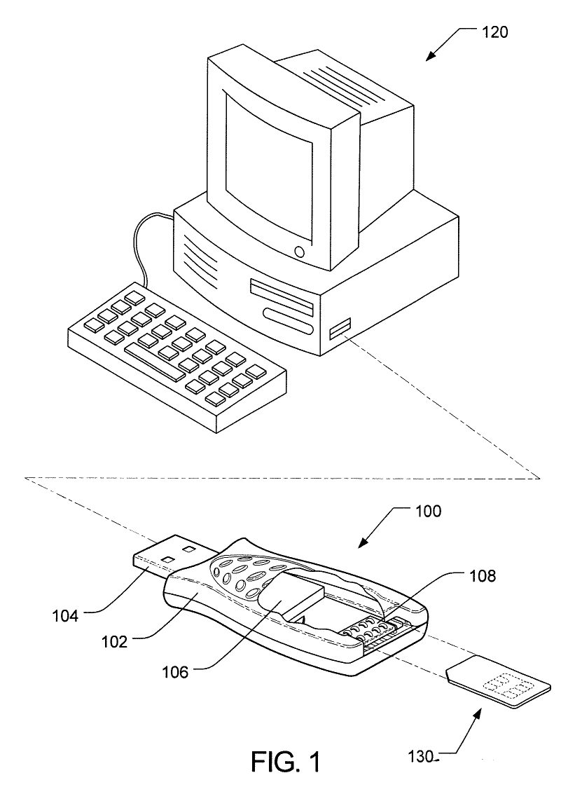

One system for providing read and write access to a high-capacity SIM is a USB device adapter removably connected to a USB host, such as a personal computer. FIG. 1 is a diagram illustrating a system using a storage adapter device to access a non-volatile memory card, in accordance with an embodiment. A system to access a non-volatile memory card may consist of a host 120, an adapter 100, and a non-volatile memory card 130. The adapter 100 comprises an enclosure 102, containing a connector 104, a memory controller 106, and a receptacle 108 that may accept and provide electrical contact with a non-volatile memory card 130. In one embodiment, the connector 104 is a USB connector. The adapter 100 preferably does not contain non-volatile memory suitable for storage of host data other than the removable memory it receives, however it may also contain its own non-volatile memory suitable for storage of host data, and not removable from the adapter 100, in other embodiments.

The host 120 may be any device capable of reading, modifying, or writing data to a non-volatile memory, including a personal computer, a laptop computer, various data communication devices, digital cameras, mobile telephones, portable audio players, portable video players, automobile sound systems, home audio and video players and televisions, and similar types of equipment. The non-volatile memory card 130 may be SIM card, R-UIM card, or Smart Card containing storage at least partially accessible over an ISO 7816 interface and a high-speed interface such as MMC, SD, USB, or SATA.

A user may insert the non-volatile memory card 130 into the receptacle 108 of the adapter 100, thereby establishing a plurality of electrical connections between the memory controller 106 and the non-volatile memory card 130. A user may establish a communication connection between the adapter 100 and host 120. If connector 104 is a USB connector, a user may establish a connection by inserting the connector 104 of the adapter 100 into a USB port of a host 120, where the host 120 may establish a communication link with memory controller 106. The order in which connections are established may be reversed. For example, an adapter 100 with an empty receptacle 108 may be communicatively connected to a host 120, and then a non-volatile memory card 130 may be inserted into the receptacle 108 of the adapter 100. Once the non-volatile memory card 130 is inserted into the receptacle 108 of the adapter 100, and the communication connection is established between the adapter 100 and host 120, the host 120 may begin accessing the non-volatile storage of the non-volatile memory card 130.

In one embodiment, the host 120 communicates with the adapter 100 through the connector 104, utilizing the USB protocol. Through a process commonly referred to as USB enumeration, the host 120 may send a series of transmissions to determine the qualities of the USB device, the adapter 100, connected to the host 120. In one example, the host 120 is a personal computer using the Microsoft Windows operating system. In one embodiment, the memory controller 106 of the adapter 100 may respond by communicating to the host 120 that one USB mass storage class (MSC) device, one USB Ethernet Emulation Model (EEM) device, and one USB Circuit Card Interface Device (CCID) device are present. The USB MSC and USB EEM devices may represent the storage space of the non-volatile memory card 130 and web server of the non-volatile memory card 130 accessible over the high speed interface, respectively. The code storage for the web server accessible over the USB EEM interface may be a partition of the storage space within the non-volatile memory card 130. The USB CCID device may represent the storage space of the non-volatile memory card 130 accessible over the ISO 7816 interface. In this example, after USB enumeration, the non-volatile memory card 130 may be treated as multiple devices in the Microsoft Windows Control Panel Device Manager Display in the host 120. The storage of the non-volatile memory card 130 accessible over the USB MSC interface may be mapped to the Windows operating system as one or more logical disk drives with separate drive letter assignments, or a single logical disk drive with one or more partitions. The web server content accessible over the USB EEM interface may be accessible with a web browser. The storage contents accessible over the USB CCID interface may be accessible utilizing a Smart Card or SIM manager application running on the host.

If the adapter 100 also contains its own separate non-volatile memory suitable for storage of host data and not removable from the adapter 100, the memory controller 106 of the adapter 100 might report an additional USB mass storage class device to the host 120, and thus the separate non-volatile memory is treated as another device in the Microsoft Windows Control Panel Device Manager Display in the host 120. Further, this separate non-removable non-volatile memory within the adapter 100 may be mapped to the Windows operating system as another separate logical disk drive with a separate drive letter assignment, or another partition of the aforementioned single logical disk drive.

Once connected, the host 120 may read, modify, and write data to a non-volatile memory card 130. For example, the host 120 transmits a command to the memory controller 106 to read or write data in the non-volatile memory card 130. Depending on the command received from the host 120, the memory controller 106 then accesses the non-volatile memory card 130 over the high-speed interface or the ISO 7816 interface. The memory controller 106 may receive read data from the non-volatile memory card 130, or an acknowledgment of a successful write operation, over the same interface. The memory controller 106 then transmits this result to the host 120.

While FIG. 1 shows a USB communications link between the adapter 100 and the host 120, through the connector 104, various other embodiments may not be limited to this configuration. The adapter 100 may utilize any wired or wireless connection suitable for transmitting or receiving data, such as an IEEE 1394 wired connection, or an IEEE 802.11 wireless connection. In these cases, the USB connector 104 may be replaced with a wired connector as required by a particular wired interface standard, or an antenna or other wireless transmitter/receiver as required by a particular wireless standard. If a wireless connection is utilized, the adapter 100 may further comprise a power source, such as a power adapter or battery receptacle, suitable for providing power to the adapter 100.

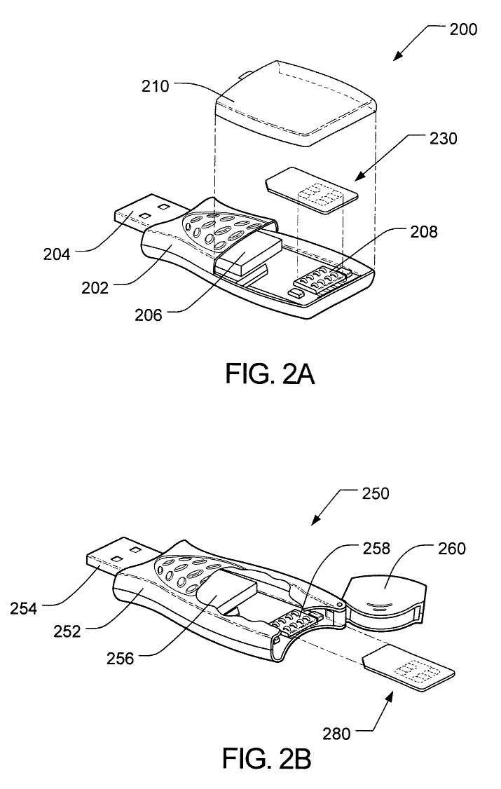

The enclosure 102 of the adapter 100 of FIG. 1 allows the receptacle to be readily accessible to a user wishing to insert or remove a non-volatile memory card 130. In other embodiments, it may be desirable to conceal or protect the receptacle. FIG. 2A is a diagram illustrating an additional embodiment of an enclosure for a storage adapter. In one embodiment, an adapter 200 comprises an enclosure 202 with a cover 210, containing a connector 204, a memory controller 206, and a receptacle 208 that may accept and make electrical connections with a non-volatile memory card 230. In this embodiment, the receptacle 208 is accessible when the cover 210 is removed from the enclosure 202. When a non-volatile memory card 230 is inserted into the receptacle 208, the cover 210 may be reattached to the enclosure 202. In this embodiment, the enclosure 202, and attached cover 210, may protect the receptacle 208 and the installed non-volatile memory card 230 from mechanical damage or electrical damage.

FIG. 2B is a diagram illustrating a yet another embodiment of an enclosure for a storage adapter. In this embodiment, an adapter 250 comprises an enclosure 252 with a door 260, containing a connector 254, a memory controller 256, and a receptacle 258 that may accept and make electrical connections with a non-volatile memory card 280. In this embodiment, the receptacle 258 is accessible when the door 260 is opened. The door 260 may be connected to the enclosure 252 with a hinge or other suitable hardware that allows the door 260 to be opened, providing access to the receptacle 258 to insert or remove the non-volatile memory card 280. Other door structures will be apparent to those of skill in the relevant art. When a non-volatile memory card 280 is inserted into the receptacle 258, the door 260 may be closed again. In this embodiment, the enclosure 252 may protect the receptacle 258 and the installed non-volatile memory card 280 from mechanical damage or electrical damage when and the door 260 is closed.

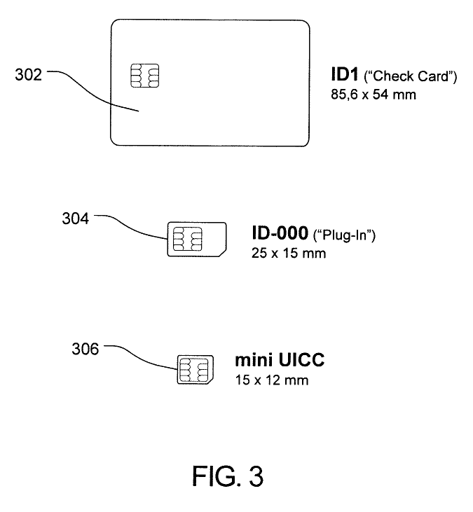

To ensure backwards-compatibility, a high-capacity SIM card, R-UIM, or Smart Card may utilize the same physical form factors as a typical SIM card, R-UIM, or Smart Card. FIG. 3 is a diagram illustrating some of the non-volatile memory card form factors that may be utilized with a storage adapter, in accordance with an embodiment. The European Telecommunications Standards Institute (ETSI) has specified a variety of form factors for Subscriber Identity Modules (SIMs). SIM cards may be manufactured in several sizes, including the “ID1” or “Check Card” form factor 302, the “ID-000” or “Plug-In” form factor 304, and the “mini-UICC” form factor 306. Similarly, R-UIM cards may be manufactured in the same form factors 302, 304, and 306, as the 3rd Generation Partnership Project 2 (3GPP2) has specified that the R-UIM card form factors mimic those of SIM cards. Smart Cards may typically utilize the “ID1” form factor 302, but may also utilize smaller form factors such as the “ID-000” or “Plug-In” form factor 304, or the “mini-UICC” form factor 306. Hence, the receptacle 108 of the adapter 100 of FIG. 1 may accommodate a non-volatile memory card in one of the above form factors 302, 304, and 306, or any other form factor specified in the ISO 7816 standard or related standards.

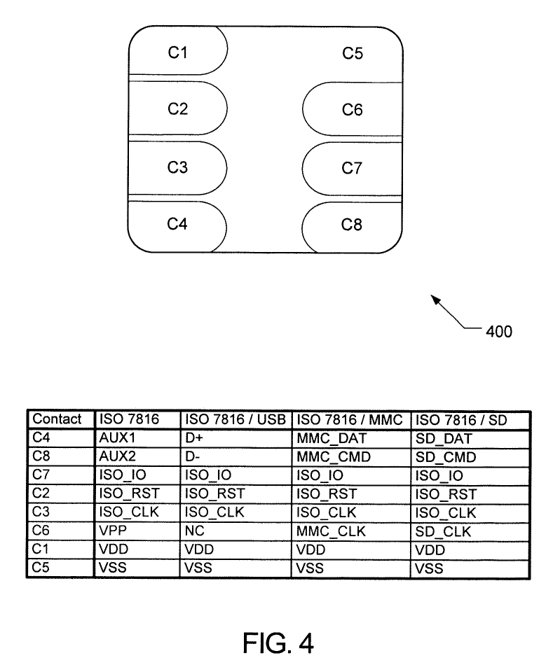

All of the card form factors 302, 304, and 306 of FIG. 3 utilize a similar electrical contact area, as specified in the Part 2 of the ISO 7816 standard. FIG. 4 is a diagram illustrating exemplary electrical contact assignments that may be used by a non-volatile memory card, in accordance with an embodiment. An electrical contact area 400 on a SIM card, R-UIM card, or Smart Card comprises eight electrical contacts, labeled C1-C8. For an ISO 7816 interface, contacts C1 and C5 provide electrical power voltage and ground reference to the circuitry within the card, and contacts C7, C2, and C3 provide the bidirectional data, reset, and clock signals, respectively, for the ISO 7816 interface. Contact C6 may provide a programming voltage to earlier generation cards, and contacts C4 and C8 are unused.

A high-speed interface may be added to a SIM, R-UIM or Smart Card by utilizing contacts C4, C6, and C8 of electrical contact area 400. In one example, a USB electrical interface may be added by assigning C4 and C8 to the D+ and D− data signals of a typical 4-pin USB interface. In another example, a Multimedia Card electrical interface may be added by assigning C4, C6, and C8 to the data, clock, and command signals of a typical Multimedia Card interface. In yet another example, a Secure Digital electrical interface may be added by assigning C4, C6, and C8 to the data, clock, and command signals of a typical Secure Digital Card interface. Because the exemplary USB, MMC, and SD high-speed interfaces may not utilize any of the ISO 7816 signal interface pins, a non-volatile memory card may be capable of being accessed through both the high-speed and ISO 7816 interfaces.

In another embodiment, a SATA interface may be added to a SIM, R-UIM, or Smart Card. A SATA electrical interface may require four additional data signals, where two of the additional differential data signals are utilized for transmission of data, and two of the additional differential data signals are utilized for reception or data. In one embodiment, electrical contact area 400 may be modified to add the additional electrical contact or contacts required. In another embodiment. In another embodiment, one or more of the ISO 7816 contacts, C2, C3, and C7 are utilized by the SATA interface, and the ISO 7816 may be disabled, or alternatively, eliminated.

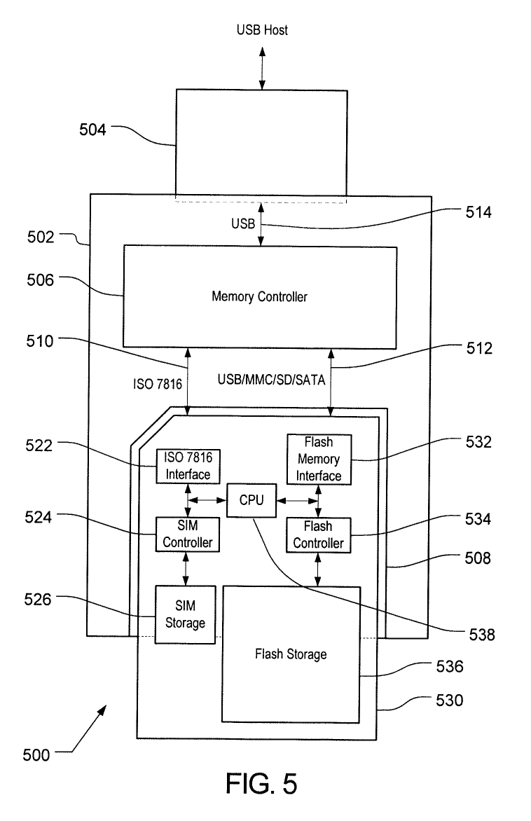

Returning briefly to FIG. 1, there are a variety of possible implementations for the adapter 100 capable of accessing a non-volatile memory card 130 through two communication interfaces. FIG. 5 is a diagram illustrating an exemplary system for accessing a removable non-volatile memory card, in accordance with an embodiment. A system 500 comprises a connector 504, an enclosure 502, a memory controller 506, and a receptacle 508. The connector 504 may be in communication with the memory controller 506 over a communications interface 514. In one embodiment, the connector 504 is a Universal Serial Bus (USB) connector, and a USB host may send commands to and receive data from the memory controller 506 according to the USB protocol, through a connection with the USB connector 504 and the communications interface 514. An electrical power supply voltage and ground reference may also be supplied to the system 500 through the connector 504, or may be provided from a separate source. The receptacle 508 may be in communication with the memory controller 506 over an ISO 7816 communications interface 510, and a high-speed interface 512. The high-speed interface 512 may be a Universal Serial Bus interface, MultiMedia Card interface, Secure Digital interface, or any interface suitable for communicating with a non-volatile memory card.

The non-volatile memory card 530 may be inserted into and removed from the receptacle 508. The receptacle 508 may accommodate a variety non-volatile memory card form factors, including, but not limited to, UICC ID1, UICC ID-000, and mini-UICC form factor cards. When the non-volatile memory card 530 is inserted into the receptacle 508, the receptacle may connect a plurality of electrical contacts of non-volatile memory card 530 to electrical contacts in the receptacle 508, which, in turn, are communicatively coupled to signals in the ISO 7816 interface 510, and signals in the high speed interface 512. An electrical power supply voltage and ground reference suitable for providing electrical power to the non-volatile memory card 530 may also be provided through the receptacle 508. The memory controller 506 may detect the insertion of the non-volatile memory card 530 into the receptacle 508, and may determine if the ISO 7816 interface 510, the high-speed interface 512, or both communication interfaces, may be used to communicate with the non-volatile memory card 530.

The non-volatile memory card 530 may comprise a processor 538, an ISO 7816 communications interface 522, a SIM controller 524, and non-volatile SIM storage 526, and may also comprise a flash memory interface 532, a flash controller 534, and a non-volatile flash storage 536. In some cards, the non-volatile SIM storage 526 and non-volatile flash storage 536 may be portions or partitions of the same non-volatile memory, such as separate address regions of memory. In some implementations of the non-volatile memory card 530, a processor 538 may allow security features of the SIM controller 524 to limit or block access to the non-volatile flash storage 536 accessed through the flash controller 534.

Because the memory controller 506 may detect which communication interface 510, 512 may be used to communicate with the non-volatile memory card 530, the system 500 may also accept and communicate over the ISO 7816 interface 510 with a non-volatile memory card 530, such as a legacy SIM card, R-UIM card, or Smart Card, does not contain a flash memory interface 532, a flash controller 534, and a non-volatile flash storage 536. Similarly, the system 500 may accept and communicate over the high-speed interface 512 with a non-volatile memory card 530, such as a flash device implemented in a UICC ID1, UICC ID-000, or mini-UICC form factor, which does not contain an ISO 7816 communications interface 522.

A host, such as a USB host, in communication with the system 500 may send data to and receive data from the non-volatile memory card 530 inserted in the receptacle 508, utilizing either the ISO 7816 interface 510, or the high-speed interface 512. Referring back FIG. 1, a non-volatile memory card 130 inserted into an adapter 100 in communication with a host 120 over a Universal Serial Bus protocol may appear as multiple devices to a host such as a personal computer running a Microsoft Windows operating system, where each device is separately accessible utilizing the USB CCID driver, the USB EEM driver, or the USB MSC driver. This may occur because the memory controller 506 may treat the non-volatile storage accessible over the ISO 7816 interface 510 and the high-speed interface 512 as multiple devices, even though the storage is contained within the same non-volatile memory card 530.

In one example, the host sends a command to the system 500 to write data to the storage accessible over the ISO 7816 interface 510. The memory controller 506 receives the write command from the host through the USB connector 504 and the USB communications interface 514. The memory controller 506 may determine that the received command is addressed to the storage accessible on the ISO 7816 interface 510, and may formulate a corresponding write command and transmit the command to the non-volatile memory card 530 over the ISO 7816 interface 510. The command may be received by the ISO 7816 communications interface 522, and the SIM controller 524 may store the received data in the non-volatile SIM storage 526. The memory controller 506 may receive an acknowledgement from the ISO 7816 communications interface 522 of the non-volatile memory card 530 over the ISO 7816 interface 510, and the memory controller 506 may send a corresponding acknowledgement to the host over the communications interface 514 and the USB connector 504. Similarly, a host may send a command to the system 500 to read data from the storage accessible over the ISO 7816 interface 510.

In another example, the host sends a command to the system 500 to write data to the storage accessible over the high-speed interface 512. The memory controller 506 receives the write command from the host through the USB connector 504 and the USB communications interface 514. The memory controller 506 may determine that the received command is addressed to the storage accessible on the high-speed interface 512, and may formulate a corresponding write command and transmit the command to the non-volatile memory card 530 over the high-speed interface 512. The command may be received by the flash memory interface 532, and the flash controller 524 may store the received data in the flash storage 534. In one implementation of the non-volatile memory card 530, the processor 538 allows security features within the SIM controller 524 to limit or block write access to at least some portions the non-volatile flash storage 536 accessed through the flash controller 534. When the write access is complete, the memory controller 506 may receive an acknowledgement from the flash memory interface 532 of the non-volatile memory card 530 over the high-speed interface 512, and the memory controller 506 may send a corresponding acknowledgement to the host over the communications interface 514 and the USB connector 504. Similarly, a host may send a command to the system 500 to read data from the storage accessible over the high-speed interface 512.

In the above example, if the processor 538 blocks the write or read access to the non-volatile flash storage 536, the memory controller 506 may receive a status, result, flag, lack of acknowledgement, or other indication that the access failed, from the flash memory interface 532 of the non-volatile memory card 530. The memory controller 506 may send a corresponding notification of the failure of the write or read access to the host over the communications interface 514 and the USB connector 504.

In another embodiment, the system 500 may further comprise a non-removable non-volatile memory. This memory may be controlled by the memory controller 506 over a communications interface within the system 500, similar to the communications interfaces 510 and 512. Unlike the non-volatile memory card 530, the non-removable non-volatile memory may not be removed from the system 530. In one embodiment, the non-removable non-volatile memory is fixed to the same printed circuit board as the memory controller 506. The protocol utilized by the memory controller 506 to access non-removable non-volatile memory may be different from the protocols utilized by the other communications interfaces 510 and 512. The system 500 may accept host write and read commands to access the storage in the non-removable non-volatile memory, independent of whether the receptacle 508 contains a non-volatile memory card 530. When the system 500 is in communicative contact with a host, such as a personal computer running a Microsoft Windows operating system, the non-removable non-volatile memory may appear as a separate logical drive, a separate partition of the same logical drive, or a separate device to the host. Thus, when a non-volatile memory card 530 is inserted into the receptacle 508, the non-removable non-volatile memory may appear as one of three logical drives, logical partitions, or devices.

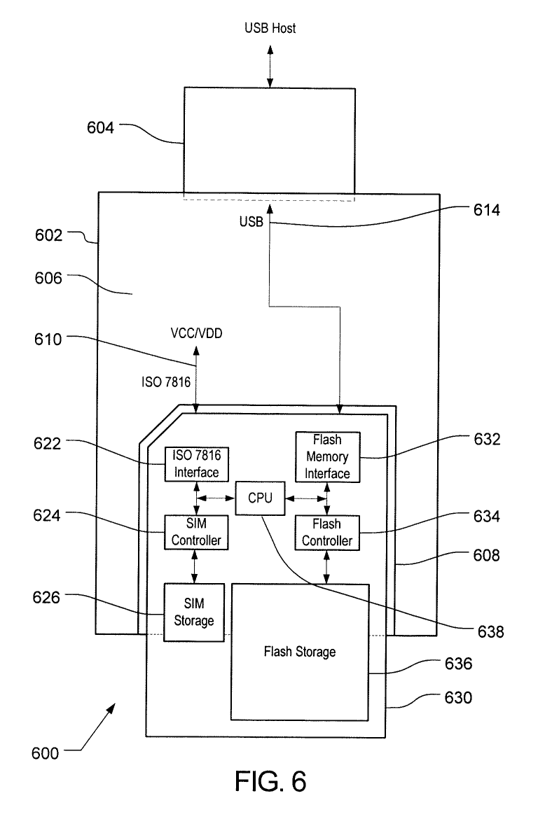

Returning briefly to FIG. 1, another implementation of the adapter 100 may allow access to only to the high-speed interface of the non-volatile memory card 130. In one embodiment, if the high-speed interface on the non-volatile memory card 130 is a USB interface, and the host 120 and the adapter 100 communicate using a USB protocol, the design of the adapter 100 may be greatly simplified. FIG. 6 is a diagram illustrating an exemplary system for accessing a removable non-volatile memory card, in accordance with an embodiment. A system 600 comprises a USB connector 604, an enclosure 602, and a receptacle 608. The USB connector 604 may be in communication with the receptacle 608 over a USB communications interface 614. In comparison to the system 500 of FIG. 5, a memory controller may not be necessary to transmit and receive data according to the USB protocol between the connector 604 and the receptacle 608. A USB host may send commands to and receive data from the receptacle 608 according to the USB protocol. An electrical power supply voltage and ground reference may also be supplied to the system 600 through the USB connector 604, or may be provided through a separate source.

A non-volatile memory card 630 may be inserted into and removed from the receptacle 608. The receptacle 608 may accommodate a variety non-volatile memory card form factors, including, but not limited to, UICC ID1, UICC ID-000, and mini-UICC form factor cards. When the non-volatile memory card 630 is inserted into the receptacle 608, the receptacle may connect a plurality of electrical contacts of the non-volatile memory card 630 to electrical contacts in the receptacle 608, which, in turn, are communicatively coupled to signals in the ISO 7816 interface 610, and signals in the USB communications interface 614. An electrical power supply voltage and ground reference suitable for providing electrical power to the non-volatile memory card 630 may also be provided through the receptacle 608. Whereas the ISO 7816 interface 510 in FIG. 5 is coupled to a memory controller 506, the ISO 7816 interface 610 is disabled. In one embodiment, the ISO 7816 interface 610 may be disabled by electrically connecting each card input signal of the ISO 7816 interface 610 to a power voltage (VCC), a ground reference (VDD), or other static voltages, possibly through passive components such as pull-up or pull-down resistors, as appropriate to disable the interface. In doing so, the ISO 7816 interface 622 of the non-volatile memory card 630 may be inactive, and may not transmit or receive data into or out of the non-volatile memory card 630.

The non-volatile memory card 630 may comprise a processor 638, an ISO 7816 communications interface 622, a SIM controller 624, and non-volatile SIM storage 626, and may also comprise a flash memory interface 632, a flash controller 634, and a non-volatile flash storage 636. In some cards, the non-volatile SIM storage 626 and non-volatile flash storage 636 may be portions or partitions of the same non-volatile memory, such as separate address regions of memory. In some implementations of the non-volatile memory card 630, a processor 638 may allow security features of the SIM controller 624 to limit or block access to the non-volatile flash storage 636 accessed through the flash controller 634.

Because the system 600 may only communicate with the non-volatile memory card 630 over the USB communications interface 614, the system 600 may also accept and communicate with a non-volatile memory card 630, such as a flash device implemented in a UICC ID1, UICC ID-000, or mini-UICC form factor, which does not contain an ISO 7816 communications interface 522.

The USB host communicatively connected with the system 600 may detect the insertion of the non-volatile memory card 630 into the receptacle 608. A host, such as a USB host, in communication with the system 600 may send data to and receive data from the non-volatile memory card 630 inserted in the receptacle 608, utilizing the USB communications interface 614. Exemplary transmissions may include writing data to and read data from the storage within the non-volatile memory card 630. To a host such as a personal computer running a Microsoft Windows operating system, the accessible storage within a non-volatile memory card 630 inserted into a receptacle 608 of a system 600 in communication with the host may appear as one or more devices to the host, where each device may be accessible through an appropriate driver such as a USB mass storage class (MSC) device, or a USB Ethernet Emulation Model (EEM) device class driver. Non-volatile storage within the non-volatile memory card 630 that is accessible only through the ISO 7816 interface may be inaccessible by the host. Additionally, circuits or logic configurable only through the ISO 7816 interface may not be configurable by the host. For example, if the SIM controller 624 is only configurable through the ISO 7816 communications interface 622, the processor 638 may disallow accesses to portions of the non-volatile flash storage 636 accessed through the flash controller 634 that might otherwise be allowed. The features and storage of the non-volatile memory card 630 accessible through the USB communications interface 614, however, may still be configured and accessed by the host through the appropriate driver or drivers.

While some aspects of the systems and methods may have been described with respect to the use of Subscriber Identity Module (SIM) cards, these embodiments may not be so limited. Embodiments in accordance with various principles of the present invention may also be implemented in systems that utilize other card formats, such as Smart Card or R-UIM cards. Moreover, although various principles of the invention has been described with respect to various exemplary embodiments, it will be understood that the invention is entitled to protection within the full scope of the appended claims.

1. A non-volatile memory interface device, comprising:
a first communication interface configured for communicating with a host according to a first protocol;
a second communication interface configured for a second protocol;
a third communication interface configured for a third protocol;
a memory controller configured to selectively communicate between said first communication interface and said second communication interface, and between said first communication interface and said third communication interface; and
a receptacle adapted to receive a removable non-volatile memory card, wherein said receptacle comprises a plurality of electrical contacts arranged to be in conductive contact with at least one electrical contact of said removable non-volatile memory card, and wherein said second communication interface and said third communication interface are communicatively coupled to said electrical contacts of said receptacle.

2. The non-volatile memory interface device of claim 1, wherein said first protocol is a Universal Serial Bus protocol.

3. The non-volatile memory interface device of claim 1, wherein said second protocol is an ISO 7816 protocol.

4. The non-volatile memory interface device of claim 1, wherein said third protocol is a Universal Serial Bus protocol.

5. The non-volatile memory interface device of claim 1, wherein said third protocol is a MultiMedia Card protocol.

6. The non-volatile memory interface device of claim 1, wherein said third protocol is a Secure Digital protocol.

7. The non-volatile memory interface device of claim 1, wherein said removable non-volatile memory card is a UICC ID1 form factor card.

8. The non-volatile memory interface device of claim 1, wherein said removable non-volatile memory card is a UICC ID-0000 form factor card.

9. The non-volatile memory interface device of claim 1, wherein said removable non-volatile memory card is a mini-UICC form factor card.

10. The non-volatile memory interface device of claim 1, wherein said memory controller is further adapted to detect the availability of said second communication interface and said third communication interface for communication with said removable non-volatile memory card.

11. The non-volatile memory interface device of claim 1, further comprising:
a non-removable non-volatile memory, wherein said non-removable non-volatile memory is communicatively coupled to said memory controller over a third interface in a third protocol.

12. The non-volatile memory interface device of claim 1, wherein only said removable non-volatile memory card is controlled by said memory controller.

13. A non-volatile memory interface device configured to receive a removable non-volatile memory card, wherein said removable non-volatile memory card is at least partially accessible through two communication interfaces, comprising:
a Universal Serial Bus interface;
a receptacle adapted to receive said removable non-volatile memory card, wherein said receptacle comprises a plurality of electrical contacts arranged to be in conductive contact with at least one electrical contact of said removable non-volatile memory card; and
a memory controller communicatively coupled to said Universal Serial Bus interface and said receptacle, said memory controller being arranged for communication with said removable non-volatile memory card utilizing at least one of said two communication interfaces, each said communication interface having a different protocol, said memory controller being further adapted to communicate with said Universal Serial Bus interface utilizing a Universal Serial Bus protocol.

14. The non-volatile memory interface device of claim 13, wherein one said protocol is an ISO 7816 protocol.

15. The non-volatile memory interface device of claim 13, wherein one said protocol is a Universal Serial Bus protocol.

16. The non-volatile memory interface device of claim 13, wherein one said protocol is a MultiMedia Card protocol.

17. The non-volatile memory interface device of claim 13, wherein one said protocol is a Secure Digital protocol.

18. The non-volatile memory interface device of claim 13, wherein said removable non-volatile memory card is a UICC ID1 form factor card.

19. The non-volatile memory interface device of claim 13, wherein said removable non-volatile memory card is a UICC ID-0000 form factor card.

20. The non-volatile memory interface device of claim 13, wherein said removable non-volatile memory card is a mini-UICC form factor card.

21. The non-volatile memory interface device of claim 13, wherein said memory controller is further adapted to detect the availability of said communication interfaces for communication with said removable non-volatile memory card.

22. The non-volatile memory interface device of claim 13, further comprising:
a non-removable non-volatile memory, wherein said non-removable non-volatile memory is communicatively coupled to said memory controller over a third communication interface in a third protocol.

23. The non-volatile memory interface device of claim 13, wherein only said removable non-volatile memory card is controlled by said memory controller.

24. A non-volatile memory interface device configured to receive a removable non-volatile memory card, wherein said removable non-volatile memory card is at least partially accessible in an ISO 7816 protocol and a second protocol, comprising:
a receptacle adapted to receive said removable non-volatile memory card, wherein said receptacle comprises a plurality of electrical contacts arranged to be in conductive contact with at least one electrical contact of said removable non-volatile memory card;
a Universal Serial Bus connector;
a memory controller communicatively coupled to said Universal Serial Bus connector and said receptacle, adapted to store data to and read data from said removable non-volatile memory card when said card is received in said receptacle according to said ISO 7816 protocol and said second protocol, further adapted to transmit data to and receive data from said Universal Serial Bus connector according to a Universal Serial Bus protocol; and
an enclosure, containing said receptacle, said Universal Serial Bus connector, and said memory controller.

25. The non-volatile memory interface device of claim 24, wherein said second protocol is a Universal Serial Bus protocol.

26. The non-volatile memory interface device of claim 24, wherein said second protocol is a MultiMedia Card protocol.

27. The non-volatile memory interface device of claim 24, wherein said second protocol is a Secure Digital protocol.

28. The non-volatile memory interface device of claim 24, wherein said removable non-volatile memory card is a UICC ID1 form factor card.

29. The non-volatile memory interface device of claim 24, wherein said removable non-volatile memory card is a UICC ID-0000 form factor card.

30. The non-volatile memory interface device of claim 24, wherein said removable non-volatile memory card is a mini-UICC form factor card.

31. The non-volatile memory interface device of claim 24, wherein said receptacle is accessible through a closable door of said enclosure.

32. The non-volatile memory interface device of claim 24, wherein said receptacle is accessible through a removable cover of said enclosure.

33. A communications adapter, configured to receive a removable non-volatile memory card, wherein said removable non-volatile memory card is at least partially accessible through a Universal Serial Bus interface and a second interface, comprising:
a receptacle adapted to receive said removable non-volatile memory card, wherein said receptacle comprises a plurality of electrical contacts arranged to be in conductive contact with at least one electrical contact of said received removable non-volatile memory card;
a Universal Serial Bus interface connector; and
an enclosure, containing said receptacle and said Universal Serial Bus connector;
wherein said Universal Serial Bus interface connector is communicatively coupled with at least two of said electrical contacts of said receptacle arranged to be in conductive contact with electrical contacts of said Universal Serial Bus interface of said non-volatile memory card;
wherein said electrical contacts of said receptacle arranged to be in conductive contact with electrical contacts of said second interface of said non-volatile memory card are individually configured to receive a constant voltage;
wherein said receptacle is adapted to receive said removable non-volatile memory card with a form factor selected from the group consisting of: UICC ID1, UICC ID-000, mini-UICC.

34. The non-volatile memory interface device of claim 33, wherein said receptacle is accessible through a closable door of said enclosure.

35. The non-volatile memory interface device of claim 33, wherein said receptacle is accessible through a removable cover of said enclosure.

36. A non-volatile memory interface device configured to receive a removable non-volatile memory card, wherein said removable non-volatile memory card is at least partially accessible through two alternative communication interfaces, comprising:
a Universal Serial Bus interface;
a receptacle adapted to receive said removable non-volatile memory card, wherein said receptacle comprises a plurality of electrical contacts arranged to be in conductive contact with at least one electrical contact of said removable non-volatile memory card; and
a memory controller communicatively coupled to said Universal Serial Bus interface and said receptacle, said memory controller being adapted to communicate with said Universal Serial Bus interface utilizing a Universal Serial Bus protocol, said memory controller being further arranged for communication with said removable non-volatile memory card utilizing one of said two communication interfaces, wherein the first said communication interface utilizes an ISO 7816 protocol, and the second said communication interface utilizes a protocol selected from the group consisting of: MultiMedia Card, Secure Digital, Serial Advanced Technology Attachment.
